(19) United States
(12) Patent Application Publication
(10) Pub. No.: US 2017/0267809 A1
(43) Pub. Date: Sep. 21, 2017

(54) A CURABLE EPOXY RESIN COMPOSITION AND A CURATIVE THEREFOR

(71) Applicant: Dow Global Technologies LLC, Midland, MI (US)

(72) Inventors: Kevin J. Meyer, Houston, TX (US); Gary A. Hunter, Lake Jackson, TX (US); Douglas L. Potts, Clute, TX (US); William L. Ritter, Brazoria, TX (US)

(21) Appl. No.: 15/505,629

(22) PCT Filed: Nov. 24, 2015
(86) PCT No.: PCT/US2015/062294

§ 371 Date: Feb. 22, 2017

Related U.S. Application Data
(60) Provisional application No. 62/086,895, filed on Dec. 3, 2014.

(51) Int. Cl. C08G 59/50; C08G 59/24; C08G 59/68

(52) U.S. Cl. CPC C08G 59/5026; C08G 59/504; C08G 59/687; C08G 59/245

(57) ABSTRACT

An amine hardener system useful for curing a curable resin composition including a blend of: (I) a first amine hardener comprising at least one cycloaliphatic amine; and (II) a second amine hardener comprising at least one polyetheramine; and a curable epoxy resin composition including (A) at least one epoxy resin compound; and (B) at least one curing agent; wherein the at least one curing agent includes the above amine hardener system.

### FIELD

The present invention is related to a curable epoxy resin composition and a hardener system for said curable epoxy resin composition. The curable epoxy resin composition is advantageous for producing a tunable, quick-curing curable epoxy resin composition that is useful in filament winding applications.

### BACKGROUND

Amine hardeners and anhydride hardeners can be used in curable epoxy resin compositions which are formulated for various applications such as for the manufacture of composites. Generally, amine and anhydride hardeners used for curing epoxy resins exhibit two different viscosity profiles. When an amine curative is used to cure an epoxy resin composition, a steady viscosity build (for example, from an initial mixed system viscosity of 1,000 millipascals-seconds (mPa-s), after one hour a mixed system viscosity of 2,000 mPa-s, after two hours a mixed system viscosity of 3,000 mPa-s, and so on) is observed through the curing cycle. On the other hand, when an anhydride curative is used to cure an epoxy resin composition, a gradual decrease in viscosity (typically, around one half of the initial mixed system viscosity; for example, from 1,000 mPa-s to 500 mPa-s) is first observed until a sharp increase (at least a doubling of viscosity in less than (<) an hour; for example, increasing viscosity from 1,000 mPa-s to 3,000 mPa-s in 45 minutes) in viscosity occurs at some time later during the curing cycle. The decrease in viscosity phenomena of the epoxy resin composition using an anhydride curative during cure is undesirable for operators using an anhydride curative system because during the decrease of viscosity phenomena the resin can drain out of the composite being produced which, in turn, results in an increase production of undesirable fiber fractions. Therefore, it would be a benefit to the composite manufacturing industry to provide an amine hardener system that does not suffer the above disadvantages of known anhydride hardener systems.

For example, in the filament winding processes for making composites, such as filament wound pressure vessels, the use of anhydride-based curatives results in the processing problems described above; and therefore, known anhydride-based curatives are not as desirable as an amine-based hardener system. However, known amine hardeners used in an epoxy filament winding process also have some disadvantages. For example, known amine hardeners do not possess sufficient pot life (for example, a required pot life of greater than (>) 3 hours, where pot life is a doubling in initial viscosity of the mixed system) to enable the known amine hardeners to be used in a filament winding process. Therefore, there is still a need for an amine hardener system for the epoxy filament winding industry which solves the processing problems encountered with use of previously known amine curing agents.

Heretofore, curable compositions have been prepared utilizing a blend of amine hardeners, for example a cycloaliphatic amine blended with a polyetheramine. For some applications employing curable compositions containing the above known amine blend hardener system, such as in the manufacture of a composite pressure vessel, it is necessary to maintain the maximum temperature of the exotherm during the composite curing under approximately (≈) 100-110° C. due to the liner material inside the pressure vessel which is not capable of withstanding the elevated exotherm temperatures. The known compositions using blends of amines do not currently take this into account liner material properties including unacceptable exotherm temperatures of the curable composition; and thus, it is usually up to the composite vessel manufacture to develop a curing profile that is operable for specific processing characteristics required for such composite vessel manufacturing process.

It would be a benefit to the composite industry to provide a amine-based two-hardener system for a curable composition that has a longer pot life (e.g., >4 hours) and that has a steady viscosity build (e.g., from an initial mixed system viscosity of 1,000 mPa-s, after one hour a viscosity of 2,000 mPa-s, after two hours a mixed system viscosity of 3,000 mPa-s, and so on) during curing such that the curable composition can be advantageously used for manufacturing composites.

A recent development in the type IV composite pressure vessel market has shifted the liner material of choice for such pressure vessels to high density polyethylene (HDPE). However, HDPE has a much lower operating temperature (HDPE has a melting temperature of ˜100-120° C.) than previous liner materials such as aluminum (aluminum has a melting temperature of ˜660° C.). Manufacturers of composite parts require an efficient composite manufacturing process without any loss in productivity or increase in cycle time during the production of composite parts; and filament winding of composite parts is no exception. A filament winding process, for example, for producing a type IV composite pressure vessel with a HDPE liner with a fast cycle time presents a challenge balancing low cycle times (e.g., >4 hours for part production) with peak exotherm in the composite part so as to not degrade the thermoplastic HDPE liner (e.g., a peak exotherm of <110° C.). Therefore, heretofore no one has developed a satisfactory amine hardener system that can be used in filament winding applications.

For example, EP 1769 032B1 discloses the use of polyetheramines (and combinations thereof) in the curing of an epoxy resin system. EP 1769 032B1 discloses the use of polyetheramines and cycloaliphatic amines; however, there is no mention of using the disclosed amine system for a filament winding application or combining the disclosed amine system with a catalyst.

WO 2013 124251 discloses the use of a catalyzed epoxy system cured with a polyalkyloxypolyamine and an additional amine for composite systems for rotor blades useful in a wind turbine; but does not disclose anything about a filament winding application or the use of the disclosed system in conjunction with a high density polyethylene.

WO 2014 062284 discloses the use of an epoxy (that may or may not be catalyzed) cured with a cycloaliphatic amine; but does not specify the use of polyetheramines for curing the epoxy resin and does not specify the specific catalyst used. WO 2014 062284 also discloses using the disclosed curing system for manufacturing concrete; but does not describe anything about a filament winding application.

WO 2014 072449 describes a hardener which has increased toughness including the use of rubber; but does not disclose any type of associated process or application in which the disclosed hardener system can be used.

### SUMMARY

In one embodiment, the present invention is directed to an amine hardener system which can be uses in preparing a curable resin composition which, in turn, can be used in a process for manufacturing a composite part such as a filament winding process for making composite pressure vessels. For example, the amine hardener system of the present invention includes at least two (or more) amine hardeners as the amine hardener system; and when the amine hardener system is used with a thermosetting resin compound, a curable composition can be prepared that has a longer pot life (e.g., >4 hours) and that has a steady viscosity build during curing. The amine hardener system includes, for example, a blend of: (I) a first amine hardener comprising at least one cycloaliphatic amine; and (II) a second amine hardener comprising at least one polyetheramine. The curable composition includes, for example, an epoxy resin composition. And, the epoxy resin curable composition can be used in composite applications.

Another embodiment of the present invention is directed to a curable epoxy resin composition including: (A) at least one epoxy resin compound; and (B) at least one curing agent; wherein the at least one curing agent comprises the amine hardener system described above. Other optional components such as a catalyst including for example methyl-p-toluene sulfonate (MPTS) can be added to the curable resin composition. The components above are used in a concentration sufficient to tune the curing time of the curable composition with minimal impact to the thermal or mechanical properties of the curable composition or a cured thermoset product made from the curable composition.

Still another embodiment of the present invention is directed to a process for preparing the above curable epoxy resin composition.

Yet another embodiment of the present invention is directed to a cured thermoset product, such as a composite, manufactured from the above curable composition.

Even still another embodiment of the present invention is directed to a process for preparing the above cured thermoset product.

### BRIEF DESCRIPTION OF THE DRAWINGS

The following drawings illustrate non-limiting embodiments of the present invention wherein:

FIG. 1 is a graphical illustration showing a qualitative representation of viscosity build of an epoxy system cured with an amine and an anhydride and has been dramatized for the purpose of illustration. A single curing step to simplify processing conditions is highly desirable in the composite manufacturing industry. Curing an amine and an anhydride using a single, high-temperature, curing cycle will result in two different viscosity profiles as shown in FIG. 1. For a traditional anhydride system, when a high single temperature is applied, the viscosity temperature dependence is higher than the rate of reaction. Because of this inequality, the viscosity of the anhydride system drops initially. This lower viscosity causes issues like resin drainage that leads to poor fiber wet-out or inhomogeneous resin impregnation of the composite. Once the rate of the reaction of the anhydride system builds, the viscosity begins to increase. Under the same single high temperature curing conditions, an amine cured system exhibits a steady increase in viscosity.

FIG. 2 is a graphical illustration showing an experimentally determined exotherm profile versus time for different amounts of MPTS catalyst.

FIG. 3 is a graphical illustration showing gel time dependence on catalyst concentration using a Gelnorm Gel Timer at room temperature (˜22° C.).

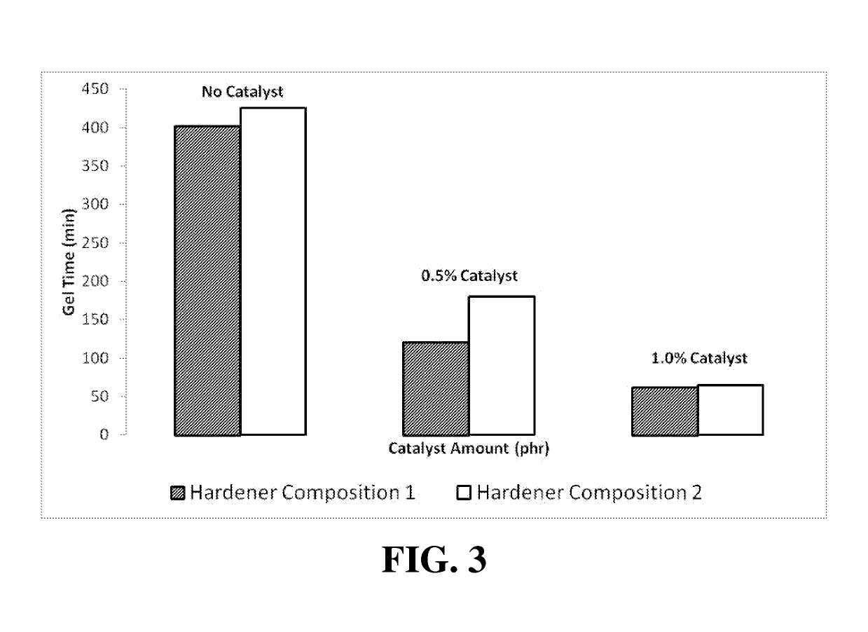

FIG. 4 is a graphical illustration showing viscosity increase as a function of time at 60° C. utilizing a two-hardener system of the present invention.

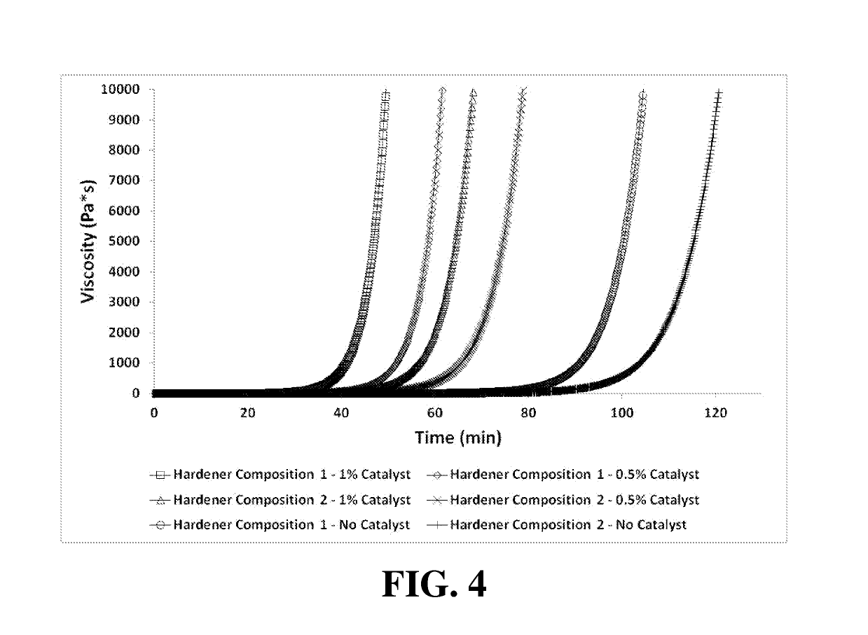

### DETAILED DESCRIPTION

One broad embodiment of the present invention includes an amine hardener system, wherein the amine hardener system may be a blend of at least two different amine compounds; that is, the amine hardener system of the present invention may include two, three, four or more different amine compounds in a blend or combination. For example, in a preferred embodiment, two different amine compounds may be used to form the amine hardener system including: (I) a first amine hardener; and (II) a second amine hardener different from the first amine hardener. The first amine hardener may include for example, at least one cycloaliphatic amine; and the second amine hardener may include for example at least one polyetheramine.

In another broad embodiment, the amine hardener system may include a third amine hardener different from the first and second amine hardener; and such third amine hardener may be blended with either the first amine hardener and/or the second amine hardener.

In still another broad embodiment, in addition to the first, second and third amine hardeners described above, the amine hardener system may include a fourth amine hardener different from the first, second and third amine hardeners; and such fourth amine hardener may be blended with the first amine hardener, the second amine hardener and/or the third amine hardener.

In yet another embodiment, the third amine hardener together with the fourth amine hardener may be blended with either the first amine hardener and/or the second amine hardener.

In even still another embodiment, the third amine hardener may be blended with either the first amine hardener and/or the second amine hardener, while the fourth amine hardener may be blended with either the first amine hardener and/or the second amine hardener.

The skilled artisan will recognize that any other number of different amine compounds, beyond the above mentioned amine compounds, can be blended together to form the amine hardener system of the present invention.

In general, to prepare the amine hardener system of the present invention, a first amine hardener is used as the first amine hardener, component (I), in the amine hardener system wherein the first amine hardener comprises at last one or more amine compounds to prepare the curing agent. In turn, the amine hardener system is blended with a second amine hardener, component (II). The term “hardener” used herein can also be referred to as a curing agent, a hardening agent, a crosslinking agent, or a curative.

In one preferred embodiment, for example, the first amine curing agent, component (I), can be (i) one amine compound, wherein the amine compound is a cycloaliphatic amine; or a (ii) a blend or combination of two or more different amine compounds provided that at least one of the amine compounds is a cycloaliphatic amine.

For example, the first amine compound can be a monofunctional cycloaliphatic amine and a difunctional cycloaliphatic amine or two monofunctional cycloaliphatic amines or two difunctional aliphatic amines or a monofunctional aromatic amine and a difunctional aromatic amine or two monofunctional aromatic amines or two difunctional aromatic amines and mixtures thereof. The cycloaliphatic amine or aromatic amine useful in the present invention preferably has a hydrogen equivalent weight (HEW) of from about 10 to about 50 in one embodiment, from about 20 to about 45 in another embodiment, and from about 30 to about 40 in still another embodiment.

In one preferred embodiment, the first amine compound useful for the present invention may include 4-methylcyclohexane-1,3-diamine; 2-methylcyclohexane-1,3-diamine; 3-aminomethyl-3,5,5-trimethylcyclohexylamine; 1,8, methane diamene; 3,3-dimethylmethylene-di(cyclohexylamine); methylene-di(cyclohexylamine); 1,2-cyclohexanediamine; and mixtures thereof.

Generally, the amount of the first amine hardener used to form the amine hardener system of the present invention will depend on the enduse of the amine hardener system. For example, as one illustrative embodiment, a curable resin formulation or composition useful for preparing a composite, can include a first amine hardener in a concentration of generally from about 10 weight percent (wt %) to about 50 wt % in one embodiment, from about 15 wt % to about 45 wt % in another embodiment; and from about 20 wt % to about 40 wt % in still another embodiment; based on the weight of the components in the amine hardener system.

In general, to prepare the amine hardener system of the present invention, a second amine hardener is used as component (II) and combined or blended with the first amine hardener, component (I) to form the amine hardener system. The second amine hardener may comprise at last one or more amine compounds to prepare the amine hardener system.

In one preferred embodiment, for example, the second amine hardener component (II), can be (i) one amine compound, wherein the amine compound is a polyether amine; or a (ii) a blend or combination of two or more different amine compounds provided that at least one of the amine compounds is a polyether amine.

For example, the second amine compound can be used in forming the hardener system may be for example a di-functional polyether amine; a tri-functional polyetheramine; and mixtures thereof.

The polyether amine useful in the present invention as the second amine hardener preferably is a 230 weight difunctional polyether amine with a HEW of from about 30 to about 70 in one embodiment, from about 40 to about 65 in another embodiment, and from about 50 to about 60 in still another embodiment.

In one preferred embodiment, the polyether amine forming the second amine compound useful for the present invention may include a number of polyoxypropylene derivatives of varying molecular weight including di-functional amines of from about 200 to about 800 molecular weight; tri-functional amines of from about 200 to about 800 molecular weight; and mixtures thereof.

Generally, the amount of the second amine hardener used to form the amine hardener system of the present invention will depend on the enduse of the amine hardener system. For example, as one illustrative embodiment, a curable resin formulation or composition useful for preparing a composite, can include a second amine hardener in a concentration of generally from about 1 wt % to about 15 wt % in one embodiment, from about 2 wt % to about 13 wt % in another embodiment; and from about 3 wt % to about 10 wt % in still another embodiment; based on the weight of the components in the amine hardener system.

As aforementioned, the amine hardener system of the present invention may be a blend of amines, including for example a combination of (1) at least a first amine compound, (2) at least a second amine compound; (3) at least a third amine compound and (4) at least a fourth amine compound, wherein at least or all four of the amine compounds are different. The blend of the amine compounds work in combination to cure the curable composition, under curing conditions, to form a cured product or thermoset. The amine hardener curing blends work together without deleteriously affecting the properties of the resultant curable composition or the resultant cured thermoset product produced from the aforementioned amine hardener system.

Other optional compounds that may be added to the amine hardener system of the present invention may include for example other amine compounds which can also be useful as the third and/or fourth amine hardener as described above; and other compounds that are normally used in curing agent formulations known to those skilled in the art. For example, optional components useful in the amine hardener system may include ethylene amines (diethylene triamine, triethylene tetraamine, and the like), propylene amines (dimethylaminopropylamine, diethylaminopropylamine, and the like), polyamidoamines (polyaminoimidizoline, and the like), alkyenediamines (hexamethylene diamene, methylpentamethylene diamene, and the like), alicyclic aliphatic amines (n-aminoethylpiperazine, and the like), araliphatic amines (metaxylenediamine, and the like); adducts of any of the aforementioned curing agents; and combinations thereof.

The process for preparing the amine hardener system of the present invention includes admixing (I) a first amine hardener; (II) a second amine hardener different from the first amine hardener; and (III) any other optional ingredients as desired. For example, the preparation of the amine hardener system of the present invention is achieved by blending, in known mixing equipment, the first and second amine hardeners, optionally any other different amine compounds, and any other desirable additives.

All the amine hardener compounds of the amine hardener system are typically mixed and dispersed at a temperature enabling the preparation of an effective amine hardener system having the desired curing properties for a curable epoxy resin composition for a particular application. For example, the amine components may be mixed at a temperature of generally from about −15° C. to about 30° C. in one embodiment, and from about 20° C. to about 25° C. in another embodiment.

The preparation of the amine hardener system of the present invention, and/or any of the steps thereof, may be a batch or a continuous process. The mixing equipment used in the process may be any vessel and ancillary equipment well known to those skilled in the art.

Some of the benefits of the amine hardener system may include for example, providing a long pot life (e.g., a pot life of >6 hours) to the curable composition in comparison with other curable composition containing other amine curing agents (typically, a pot life of from 2-4 hours), where pot life is described as a doubling in viscosity. For example, the amine hardener system prepared by the above process advantageously exhibits a pot life of from generally about 2 hours to about 3 hours in one embodiment; from about 4 hours to about 5 hours in another embodiment; and from about 6 hours to about 7 hours in still another embodiment.

In general, the amine hardener system of the present invention includes a combination of at least one cycloaliphatic amine and at least one polyetheramine; and is advantageously used in a curable resin formulation or composition. Any of the above-described amine hardener systems may be used for example in a curable resin composition useful for manufacturing a composite manufacturing process. The composite manufacturing process can be for example a filament winding process for making composite parts. Thus, another broad embodiment of the present invention includes a curable thermosetting resin composition including as one component any of the above-described amine hardener systems.

In a preferred embodiment, the curable resin composition is an epoxy resin composition or formulation. The curable epoxy resin composition may include, for example: (A) at least one epoxy resin compound; and (B) at least one curing agent; wherein the at least one curing agent comprises the amine hardener system described above. Optionally, any other desired additives typically used in curable thermosetting resin compositions can be included in the above curable epoxy resin composition.

The curable formulation of the present invention includes at least one epoxy resin as component (A). The epoxy resins used herein may be monomeric, oligiomeric, or polymeric compounds containing at least one vicinal epoxy group. The epoxy resin may be aliphatic, cycloaliphatic, aromatic, cyclic, heterocyclic or mixtures thereof. The epoxy resin may be saturated or unsaturated. The epoxy resins may be substituted or unsubstituted. An extensive enumeration of epoxy resins useful in the present invention is found in Lee, H. and Neville, K., Handbook of Epoxy Resins, McGraw-Hill Book Company, New York, 1967, Chapter 2, pages 257-307; incorporated herein by reference.

The epoxy resins, used in embodiments disclosed herein of the present invention, may vary and include conventional and commercially available epoxy resins. The epoxy resin component of the resin composition used herein may include a single epoxy resin compound used alone or a mixture of two or more epoxy compounds used in combination. The epoxy resin, also referred to as a polyepoxide, may be a product that has, on average, more than one unreacted epoxide unit per molecule. In choosing epoxy resins for compositions disclosed herein, consideration should be given to properties of the final product, and to viscosity and other properties that may influence the processing of the resin composition.

Suitable conventional epoxy resin compounds utilized in the composition of the present invention may be prepared by processes known in the art, such as for example, a reaction product based on the reaction of an epihalohydrin and (1) a phenol or a phenol type compound, (2) an amine, or (3) a carboxylic acid. Suitable conventional epoxy resins used herein may also be prepared from the oxidation of unsaturated compounds. For example, epoxy resins used herein may include reaction products of epichlorohydrin with polyfunctional alcohols, phenols, bisphenols, halogenated bisphenols, hydrogenated bisphenols, novolac resins, o-cresol novolacs, phenol novolacs, polyglycols, polyalkylene glycols, cycloaliphatics, carboxylic acids, aromatic amines, aminophenols, or combinations thereof. The preparation of epoxy compounds is described for example in Kirk-Othmer, Encyclopedia of Chemical Technology, 3rd Ed., Vol. 9, pages 267-289.

In one embodiment, suitable phenol, phenol-type or polyhydric phenol compounds useful for reacting with an epihalohydrin to prepare an epoxy resin include, for example, the polyhydric phenol compounds having an average of more than one aromatic hydroxyl group per molecule such as, for example, dihydroxy phenols; biphenols; bisphenols such as bisphenol A, bisphenol AP (1,1-bis(4-hydroxyphenyl)-1-phenyl ethane), bisphenol F, or bisphenol K; halogenated biphenols such as tetramethyl-tetrabromobiphenol or tetramethyltribromobiphenol; halogenated bisphenols such as tetrabromobisphenol A or tetrachlorobisphenol A; alkylated biphenols such as tetramethylbiphenol; alkylated bisphenols; trisphenols; phenol-aldehyde novolac resins (i.e., the reaction product of phenols and simple aldehydes, preferably formaldehyde) such as phenol-formaldehyde novolac resins, alkyl substituted phenol-formaldehyde resins, phenol-hydroxybenzaldehyde resins, alkylated phenol-hydroxybenzaldehyde resins, or cresol-hydroxybenzaldehyde resins; halogenated phenol-aldehyde novolac resins; substituted phenol-aldehyde novolac resins; phenol-hydrocarbon resins; substituted phenol-hydrocarbon resins; hydrocarbon-phenol resins; hydrocarbon-halogenated phenol resins; hydrocarbon-alkylated phenol resins; resorcinol; catechol; hydroquinone; dicyclopentadiene-phenol resins; dicyclopentadiene-substituted phenol resins; or combinations thereof.

In another embodiment, suitable amines useful for reacting with an epihalohydrin to prepare an epoxy resin include, for example, diaminodiphenylmethane, aminophenol, xylene diamine, anilines, or combinations thereof.

In still another embodiment, suitable carboxylic acids useful for reacting with an epihalohydrin to prepare an epoxy resin include, for example, phthalic acid, isophthalic acid, terephthalic acid, tetrahydro- and/or hexahydrophthalic acid, endomethylenetetrahydrophthalic acid, isophthalic acid, methylhexahydrophthalic acid, or combinations thereof.

A few non-limiting embodiments of the epoxy resin useful in the present invention include, for example, aliphatic epoxides prepared from the reaction of epihalohydrins and polyglycols such as trimethylpropane epoxide; diglycidyl-1,2-cyclohexane dicarboxylate, or mixtures thereof; diglycidyl ether of bisphenol A; diglycidyl ether of bisphenol F; resorcinol diglycidyl ether; triglycidyl ethers of para-aminophenols; halogen (for example, chlorine or bromine)-containing epoxy resins such as diglycidyl ether of tetrabromobisphenol A; epoxidized phenol novolac; epoxidized bisphenol A novolac; an oxazolidone-modified epoxy resin; an epoxy-terminated polyoxazolidone; and mixtures thereof.

Suitable commercially available epoxy resin compounds utilized in the composition of the present invention may be for example, epoxy resins commercially available from The Dow Chemical Company such as the D.E.R.™ 300 series, the D.E.N.™ 400 series, the D.E.R.™ 500 series, the D.E.R.™ 600 series and the D.E.R.™ 700 series of epoxy resins. Examples of bisphenol A based epoxy resins useful in the present invention include commercially available resins such as D.E.R.™ 300 series and D.E.R.™ 600 series, commercially available from The Dow Chemical Company. Examples of epoxy novolac resins useful in the present invention include commercially available resins such as D.E.N.™ 400 series, commercially available from The Dow Chemical Company.

For example, as one illustrative embodiment of the present invention, the epoxy resin may be a liquid epoxy resin, such as D.E.R. 383 a diglycidylether of bisphenol A (DGEBPA) having an epoxide equivalent weight of from about 175 to about 185, a viscosity of about 9.5 Pa-s and a density of about 1.16 g/cc. Other commercial epoxy resins that can be used for the epoxy resin component can be D.E.R. 330, D.E.R. 354, D.E.R. 332, or mixtures thereof.

Other suitable epoxy resins useful as component (a) are disclosed in, for example, U.S. Pat. Nos. 3,018,262; 7,163,973; 6,887,574; 6,632,893; 6,242,083; 7,037,958; 6,572,971; 6,153,719; and 5,405,688; PCT Publication WO 2006/052727; U.S. Patent Application Publication Nos. 20060293172 and 20050171237, each of which is hereby incorporated herein by reference. Examples of epoxy resins and their precursors suitable for use in the compositions of the present invention are also described, for example, in U.S. Pat. Nos. 5,137,990 and 6,451,898, which are incorporated herein by reference.

A few non-limiting examples of preferred epoxy resin compounds useful in preparing the curable epoxy resin formulation may include, for example, a bisphenol-A-based epoxy resin or a bisphenol-F-based epoxy resin such as diglycidyl ether of bisphenol A or diglycidyl ether of bisphenol F, respectively. Other preferred embodiments of the epoxy resin compound includes VORAFORCE™ TW 100, VORAFORCE™ TW 103, VORAFORCE™ TW 104, VORAFORCE™ TW 108, and mixtures thereof, which are epoxy resin compounds commercially available from The Dow Chemical Company.

In general, the concentration of the epoxy resin compound used in the present invention may range generally from about 1 wt % to about 99 wt % in one embodiment, from about 5 wt % to about 95 wt % in another embodiment, from about 10 wt % to about 90 wt % in still another embodiment, and from about 25 wt % to about 75 wt % in yet another embodiment, based on the total weight of the components in the resin composition.

In an epoxy/hardener formulation, the ratio of reactive epoxy groups to reactive amine groups is, in general, desired to be equal in one embodiment; i.e., for every reactive epoxy ring there is an equivalent amine group that the epoxy group can react with. Having more epoxy groups than amine groups will result in excess unreacted epoxy groups; and thus, the presence of excess unreacted epoxy groups in the formulation may decrease the thermal and mechanical properties of the resulting thermoset product made from the formulation. Similarly, if too little epoxy is incorporated in the formulation, the formulation will have an excess of amine groups present in the formulation; and thus, the presence of excess amine groups in the formulation may reduce the thermal and mechanical properties of the resulting thermoset product made from the formulation. This is due to the plasticizing effect of the excess amine groups.

In an amine cured epoxy system, it is desired to react all of the epoxy rings of the epoxy resin to ensure maximum mechanical properties of the resulting cured thermoset. For this reason, the amount of the amine hardener system is always calculated to achieve a goal of fully reacting all of the epoxy rings (for example, a 1:1 ratio of epoxy reactive groups to amine reactive groups can be used). If there is an excess of epoxy (using less amine hardener than specified), the cross-linked network is not as strong and the mechanical and thermal properties that the system provides to the thermoset article produced with the system decrease. If there is an excess of amine curative, the extra curing agent acts as a plasticizer and again decreases thermal and mechanical properties of the thermoset article produced with the system.

In general, the concentration of the amine hardener system used in the curable resin composition of the present invention may range from about from about 15 wt % to about 25 wt % in one embodiment, from about 13 wt % to about 23 wt % in another embodiment; and from about 19 wt % to about 22 wt % in still another embodiment; based on the weight of the components in the curable formulation. The above concentration ranges of the amine hardener system used in a curable resin composition includes the total amount of the combined amine hardeners (e.g., first, second, third, and fourth and so on) comprising the amine hardener system when two or more amine compounds are used in the amine hardener system.

In preparing the curable resin formulation of the present invention, optionally, at least one cure catalyst may be added to the curable resin formulation to facilitate or promote the reaction of the epoxy resin composition, component (A), with the amine hardener system, component (B). The curing catalyst is optional in the present invention because the amine hardener system is sufficient to cure the curable epoxy resin composition alone. When a curing catalyst is used, the optional curing catalyst useful in the present invention may include for example, any homogeneous or heterogeneous catalyst known in the art which is appropriate for facilitating the reaction between an epoxy resin and a curing agent. The catalyst may include for example, but are not limited to, imidazoles, tertiary amines, phosphonium complexes, Lewis acids, or Lewis bases, transition metal catalysts, and mixtures thereof.

The catalyst useful in the present invention may include for example a Lewis acid such as boron triflouride complexes, Lewis bases such as tertiary amines like diazabicycloundecene and 2-phenylimidazole, quaternary salts such as tetrabutyphosphonium bromide and tetraethylammonium bromide, and organoantimony halides such as triphenylantimony tetraiodide and triphenylantimony dibromide; and mixtures thereof.

In one preferred embodiment, the catalyst useful in the curable composition of the present invention may be selected from sulfonate type catalysts including for example methyl-para-toluene sulfonate (MPTS); ethyl-para-toluene sulfonate; and mixtures thereof.

Generally, the amount of cure catalyst when used in the curable composition may be for example, from 0 wt % to about 5 wt % in one embodiment, from about 0.01 wt % to about 2 wt % in another embodiment; from about 0.1 wt % to about 1 wt % in still another embodiment; and from about 0.1 wt % to about 0.5 wt % in yet another embodiment. The catalyst level can be adjusted to allow adequate processing in the final application. For example, above the concentration of 5 wt % of the cure catalyst such as MPTS in the system, the reaction rate of the composition will be so fast that the composition will not be able useful in any type of processing application. At 0 wt % of the cure catalyst such as MPTS in the system, the reaction rate will resemble that of a slow conventional amine cured epoxy.

An advantage of the curable composition of the present invention includes the ability to easily modify the chemistry by changing or tuning the concentration of the amine hardener system such that the curable composition can cure quickly or slowly, as desired, (e.g., a total part cycle time of ˜3 hours to ˜8 hours depending on specific process conditions and requirements) without change in other properties of the curable composition such as pot life, gel time, initial viscosity and final mechanical and thermal properties. For example, a very small change in the amount of the catalyst used in the composition (e.g., a change of concentration of from 0-1 percent [%] fluctuation) can drastically increase or decrease processing time thereby allowing a “tuning” of the curing time of a curable composition system to fit a particular enduse. And, fine tuning the processing of the curable composition by changing the catalyst concentration can be accomplished readily with no observable impact in thermal or mechanical properties to the cured thermoset product.

Other optional compounds that may be added to the curable composition of the present invention may include compounds that are normally used in resin formulations known to those skilled in the art for preparing curable compositions and thermosets. For example, the optional components may comprise compounds that can be added to the composition to enhance application properties (e.g., surface tension modifiers or flow aids), reliability properties (e.g., adhesion promoters) the reaction rate, the selectivity of the reaction, and/or the catalyst lifetime.

Other optional compounds or additives that may be added to the curable composition of the present invention may include, for example, de-molding agents; accelerators, a solvent to lower the viscosity of the formulation further, other resins such as a phenolic resin that can be blended with the other ingredients in the curable formulation, other curing agents different from the first and second curing agent, fillers, pigments, toughening agents, flow modifiers, adhesion promoters, diluents, stabilizers, plasticizers, catalyst de-activators, flame retardants, and mixtures thereof.

Generally, the amount of other optional components or additives, when used in the present invention, may be for example, from 0 wt % to about 75 wt % in one embodiment, from about 0.01 wt % to about 50 wt % in another embodiment; from about 0.1 wt % to about 35 wt % in still another embodiment; and from about 1 wt % to about 25 wt % in yet another embodiment. For example, to more efficiently wet out fiber bundles a reactive diluent, such as 1,4-butanedioldiglycidether (BDDGE), can be added to the system when the system will be used in a curable composition in a filament winding process. In the embodied system of the present invention, the use of a reactive diluent within the above specified ranges should not impact glass transition temperature or mechanical properties. Operating the system outside of the above specified ranges may yield less than maximum mechanical properties.

The process for preparing the curable formulation of the present invention includes admixing (a) at least one thermosetting epoxy resin compound; and (b) the amine hardener system described above; and optionally, any other optional ingredients as desired as described above. For example, the preparation of the curable resin formulation of the present invention is achieved by blending, in known mixing equipment, the epoxy resin, the amine hardener system, and optionally any other desirable additives. Any of the above-mentioned optional additives may be added to the composition during the mixing or prior to the mixing to form the formulation.

All the compounds of the curable formulation are typically mixed and dispersed at a temperature enabling the preparation of an effective curable epoxy resin formulation having the desired balance of properties for a particular application. For example, the temperature during the mixing of all components may be generally from about −10° C. to about 40° C. in one embodiment, and from about 0° C. to about 30° C. in another embodiment. Lower mixing temperatures help to minimize reaction of the epoxide and curing agent in the composition to maximize the pot life of the composition.

The preparation of the curable formulation of the present invention, and/or any of the steps thereof, may be a batch or a continuous process. The mixing equipment used in the process may be any vessel and ancillary equipment well known to those skilled in the art.

Some of the benefits of the curable composition of the present invention may include for example, low viscosity. For example, the curable epoxy formulation prepared by the above process advantageously exhibits a low viscosity for example a viscosity of less than or equal to (1 about 500 mPa-s at 25° C. Generally, the viscosity of curable composition can be from about 200 mPa-s to about 1,100 mPa-s in one embodiment, from about 300 mPa-s to about 800 mPa-s in another embodiment, and from about 400 mPa-s to about 800 mPa-s in still another embodiment at 25° C. A viscosity outside the above specified ranges will typically result is less than ideal thermal and mechanical properties. For example, using a viscosity that is below 200 mPa-s will result in viscosity that is too low for certain application processes such as a filament winding process. This can lead to resin drainage, and poor fiber bundle wet-out. Conversely, a viscosity that is over 1,100 mPa-s will result in poor fiber bundle impregnation because the resin system may not be able to interpenetrate the individual fiber tows. This will result in a heterogeneous composite.

Because the curable composition has a low viscosity as described above, the curable composition can be used without using solvents or diluents for the sole purpose of reducing the viscosity of the curable composition's processability. In other words, the curable composition can be easily processed and readily handled in enduse processes for forming thermoset products. However, in an optional preferred embodiment, a reactive diluent may be used to increase the penetration of the curable resin composition into the fiber bundles when manufacturing a fiber reinforced composite article using a filament winding process.

Another benefit of the curable resin composition of the present invention includes a curable composition that advantageously exhibits a single curing step to achieve maximum thermal and mechanical properties. Typical epoxy curing requires a multi-step curing schedule usually including two or three different temperatures. The amine curing agent of the present invention allows the curable composition to be cured with a single curing step without the need for post cure to achieve maximum mechanical and thermal properties.

The curable composition, when cured, endows the cured thermosets such as composites made from the curable composition with excellent flexibility, impact resistance, chemical resistance and other properties such as water resistance, which can be attributable to the curable composition of the present invention.

Another embodiment of the present invention includes curing the curable resin composition discussed above to form a thermoset or cured article. For example, the curing of the thermosettable or curable resin composition may be carried out at a predetermined temperature and for a predetermined period of time sufficient to cure the curable resin composition.

For example, the temperature of curing the composition may be generally from about 10° C. to about 200° C. in one embodiment; from about 25° C. to about 100° C. in another embodiment; and from about 30° C. to about 90° C. in still another embodiment; and the curing time may be chosen generally between about 1 minute to about 4 hours in one embodiment, between about 5 minutes to about 2 hours in another embodiment, and between about 10 minutes to about 1 hour in still another embodiment. Below a period of curing time of about 1 minute, the time may be too short to ensure sufficient reaction under conventional processing conditions; and above a curing time of about 4 hours, the time may be too long to be practical or economical.

The curable formulation of the present invention may be used to manufacture a cured thermoset product for various applications. The cured product (i.e., the cross-linked product made from the curable formulation) of the present invention shows several improved and beneficial performance properties. For example, the curable formulation provides a resultant cured product advantageously exhibiting a high glass transition temperature (Tg). In general, the cured product of the present invention exhibits a glass transition temperature generally between 50° C. and 150° C. in one embodiment, between about 70° C. and 140° C. in another embodiment, and between about 90° C. and 130° C. in still another embodiment. The Tg of the cured product can be measured by the method described in ASTM E1640-13 or ASTM E2602-09.

As aforementioned, some non-limiting examples of end use applications wherein the epoxy resin formulation containing the amine hardener system of present invention may be used may include, for example, composites, coatings, adhesives, inks, and any other applications that traditionally use a curable composition comprising a thermosetting resin and a curing agent.

The beneficial properties of the cured product can also be measured and evaluated to determine the desired end use of the curable composition and the cured product. For example, the curable epoxy resin composition of the present invention can be used for preparing a composite wherein the cured composite product exhibits a combination, i.e., a balance, of advantageous properties required for such composite enduse including for example processability, Tg, mechanical performance and chemical resistance performance.

In one illustrative embodiment of the present invention, the curable epoxy resin composition of the present invention and the cured product thereof as described above may be beneficially used in a filament winding process for winding type IV composite pressure vessels; particularly, when the pressure vessels utilize a high-density polyethylene liner (which has a lower operating temperature than other liners such as polyamide liners) without loss in cycle time.

In general, the filament winding process for manufacturing a cured thermoset, such as a composite pressure vessel, may include for example the following steps:

(a) passing a dry filament reinforcement material through a bed of curable epoxy resin composition comprising:
(i) at least one epoxy resin compound; and
(ii) at least one curing agent; wherein the at least one curing agent comprises the amine hardener system of the present invention;

(b) impregnating the dry filament reinforcement material with the curable resin composition to form a resin impregnated reinforcement material;

(c) winding the resin impregnated reinforcement material about the outer surface of a liner material disposed on a mandrel to form at least a partially cured composite article; and

(d) thermally curing the partially cured composite article on the liner material to form a substantially completely cured wound thermoset article.

A filament winding process and such process for producing type IV composite pressure vessels is described in “Composite Filament Winding” by T. S. Peters (ASM International, 2011), incorporated herein by reference.

### EXAMPLES

The following examples and comparative examples further illustrate the present invention in detail but are not to be construed to limit the scope thereof.

In the following Examples, standard analytical equipment and methods are used to measure properties including for example, the following:

Differential Scanning Calorimetry Measurements

Differential scanning calorimetry (DSC) is performed using a Texas Instruments DSC Q200 differential scanning calorimeter. The glass transition temperature is determined using a temperature ramp with a heating rate of 10° C./minute from 30° C. to 200° C. The samples are taken from a cured specimen and heated twice through this cycle to ensure total cure is achieved and no post cure is present.

Thermo Gravimetric Analysis Measurements

Thermo gravimetric analysis (TGA) is performed using a TA Instruments TGA Q5000 thermo gravimetric analyzer. The onset of thermal degradation is determined using a temperature ramp of 10° C./minute from 30° C. to 450° C. The onset of thermal degradation temperature is taken when the sample had reached 95% weight of the total original sample weight. The samples for analysis are taken from a cured specimen.

Viscosity Build

The viscosity build during cure is measured using an ARES Rheometer (TA Instruments) using a steady shear program. The resin and hardener are mixed in a FlackTek Mixer (SpeedMixer Model DAC 150 FV-K) to homogenize the system. The mixed system is then loaded into a parallel plate fixture with a plate diameter of 40.0 millimeter (mm) and a gap height of 1.00 mm. A dynamic temperature ramp test is used (using a constant temperature throughout) with w=1.0 Hz at a temperature of 60° C.

Gel Times

Gel times are estimated through the use of a Gelnorm Gel Timer (Gel Instrumente AG). Approximately 10 grams (g) of a formulation are placed inside of a test tube. The test tube is suspended in an oil bath heated to a predetermined temperature. A wire plunger oscillates up and down until the solution becomes too viscous for this to occur. At this point the apparatus stops and the time is recorded.

Exotherm Determination

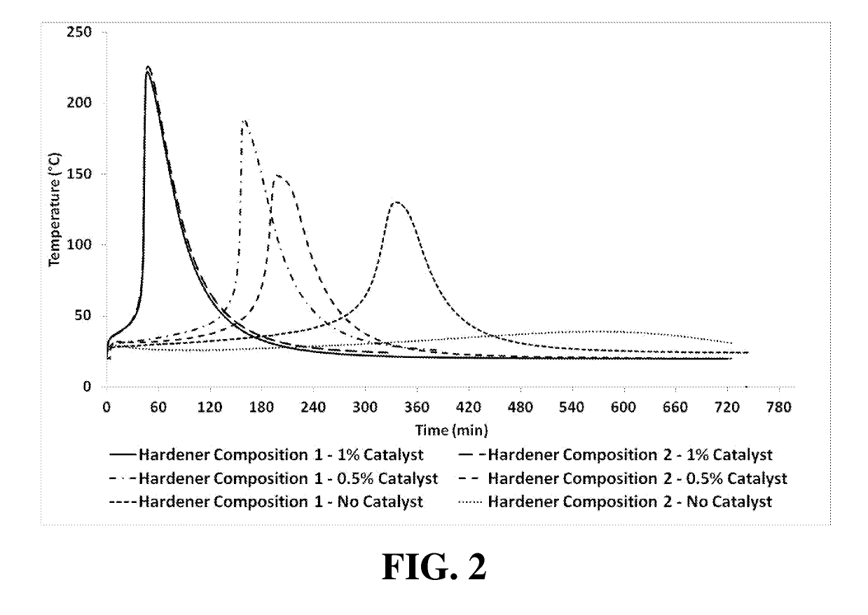

The time and temperature to the exothermic peak is determined through the use of an exotherm test. The epoxy resin, curing agents and catalyst are weighed in the ratios provided in Error! Reference source not found. and mixed in a FlackTek DAC 600 speed mixer. 100 g of the mixed resin is then transferred to a polyethylene lined paper cup and the insulating lid with attached thermocouple is placed onto the cup so that the end of the thermocouple is positioned in the geometric center of the sample. The resultant data from the exotherm test procedure is given in FIG. 2.

Mechanical Analysis

The mechanical properties of the system are tested through three methods: tensile (ASTM D638, Type 1), flexural (ASTM D790, Type A) and fracture toughness (ASTM E399). The goal of this analysis is to determine any effects that the different formulations have on mechanical properties.

In the following Examples two-blended amine curing systems were used and analysis carried out with the following objectives: (1) to determine the correlation between exotherm time and amount of catalyst by performing exothermic profile tests; (2) to determine the correlation between gel time and amount of catalyst by performing gel time tests; (3) to determine the correlation between catalyst concentration and glass transition and thermal degradation temperature by analyzing samples using DSC and TGA; and (4) to determine the effect of catalyst concentration on material properties by performing mechanical testing.

### Example 1

Part A: Formulation

The epoxy resin used in this example is a bisphenol A diglycidylether based epoxy resin to provide a formulation with a low initial viscosity of 800-900 mPa-s. The hardeners used in this example included a blend of two hardeners each hardener being a mixture of two commercial amine products. The first hardener (“Hardener #1” in Table I) was a blend of a cycloaliphatic amine; and a polyether diamine. The second hardener (“Hardener #2” in Table I) was also a blend of cycloaliphatic amine and polyether triamine. The formulation used in this Example 1 is described in Table I.

TABLE I

| | |
|---|---|
| Chemical Name | Weight % |

Resin

| | |
|---|---|
| bisphenol A diglycidylether (DGEBA) | 100 |
| methyl-p-toluene sulfonate (MPTS) | See notes (1) and |
| | (2) below |

Hardener #1

| | |
|---|---|
| >70%-<90% diaminomethylcyclohexane; | 60 |
| >10%-<30% 2-methylcyclohexane-1,3-diamine | |
| polyetherdiamine | 40 |

Hardener #2

| | |
|---|---|
| >70%-<90% diaminomethylcyclohexane; | 60 |
| >10%-<30% 2-methylcyclohexane-1,3-diamine | |
| polyethertriamine | 40 |

Notes for Table I:
(1) MPTS is preferably mixed with the resin side of the system.
(2) The percentage of MPTS is varied slightly in this Example 1 but the effect of MPTS in total weight is negligible.

Part B: Results

Differential Scanning Calorimetry and Thermo Gravimetric Analysis

A catalyst and the hardeners described in Table I were used to test the effect of the catalyst concentration on glass transition temperature and thermal degradation temperature as tested through non-isothermal DSC and non-isothermal TGA. The glass transition temperatures for the different systems are shown in Table II. The glass transition temperatures and the thermal degradation temperatures for bisphenol-A based epoxy resin and the two amine hardener blends described in Table IError! Reference source not found. are shown in Table II.

TABLE II

| | Hardener #1 | | | Hardener #2 | | |
|---|---|---|---|---|---|---|
| Catalyst | Temperature | Tg1 | Tg2 | Temperature | Tg1 | Tg2 |
| % | (° C.) | (° C.) | (° C.) | (° C.) | (° C.) | (° C.) |
| 0.0 | 349.3 | 127.6 | 131.2 | 346.9 | — | 130.3 |
| 0.5 | 316.4 | 132.8 | 135.9 | 323.7 | 125.7 | 138.2 |
| 1.0 | 318.2 | 135.5 | 136.8 | 319.1 | 140.2 | 141.1 |

It can be seen from the data in Table II

Table that the glass transition temperature (Tg) of the system cured with hardener #1 is approximately or equal to (≈) 134° C. and the Tg of the system cured with hardener #2 is ≈136° C. Overall the glass transition appears not to be effected by an increase in the catalyst. The thermal degradation temperature is observed to vary by >25° C. for both systems and decreases in relation to the amount of catalyst in the system.

Gel Time Testing

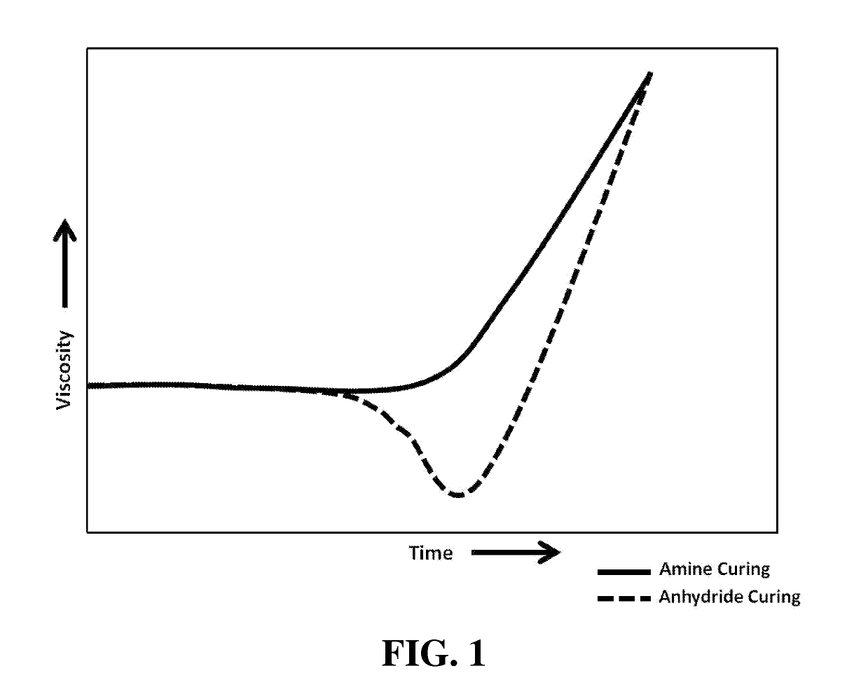

The gel times of the bisphenol-A based epoxy resin and amine cured system proposed above in Table IError! Reference source not found. are shown where the gel time is a function of catalyst percent per one-hundred grams of resin (phr). FIG. 1 shows the gel time dependence on catalyst concentration using a Gelnorm Gel Timer at room temperature (≈22° C.).

From the observed data, it can be seen that the catalyst has a non-linear effect on the gel time of the system. This observation is confirmed in subsequent sections of this document. However, it is valuable to note the wide range of gel times that can be accomplished with this system utilizing only a small amount of the MPTS catalyst.

Viscosity Build

The build viscosities of the systems were tested in an ARES Rheometer (TA Instruments) to determine the point of gelation. FIG. 2 shows the viscosity increase as a function of time at 60° C. utilizing the two hardener systems of the present invention. From the data it can be discerned that a wide range of gel times can be obtained through the use of the two different hardener systems.

Exothermic Profile Testing

A main concern in the processing of epoxy systems and epoxy composites is the exotherm peak temperature and the time it takes to reach the peak. FIG. 2 shows an exotherm profile, determined experimentally, versus time for different amounts of MPTS catalyst.

From the data above, it can be observed that at a 1% phr of MPTS yields similar times for exothermic peaks with almost the same peak temperature. At a 0% phr of MPTS the systems appear to differ greatly, with hardener blend #1 having a peak exotherm temperature of ≈125° C. at ≈5.5 hours (hr). Conversely, the hardener #2 blend exotherms at a much lower temperature (≈45° C.) at almost twice the time. The real value in the second hardener is shown to exist in formulations where the amount of catalyst is greater than zero phr but less than one phr. For example, at a concentration of 0.25 MPTS phr, a 40° C. reduction in peak exotherm temperature is achieved that requires only 20 additional minutes (min) to reach that peak.

Material Properties Testing

Previous attempts at using MPTS as a catalyst in an amine curing system showed that mechanical properties may be affected. In order for this catalyzed system to have a wide applicability mechanical properties must not decrease significantly with increased catalyst concentration. To verify that no effect of the system was incurred by the catalyst three tests were performed: tensile strength, flexural strength and fracture toughness. To keep the mechanical testing concise, three system of commercial interest were tested: (1) bisphenol-A based epoxy resin/Hardener #1, (2) catalyzed bisphenol-A based epoxy resin/Hardener #1 and (3) catalyzed bisphenol-A based epoxy resin/Hardener #2. Table III described the mechanical properties of different resin/amine hardener combinations.

TABLE III

| | | | | | | | Fracture |
|---|---|---|---|---|---|---|---|
| | | Tensile | | | Flexural | | Toughness |
| | Thermal | Strength | Modulus | Elongation | Strength | Modulus | K_{1c} |
| System | Tg (° C.) | (MPa) | (GPa) | (%) | (MPa) | (GPa) | (MPa*m^{1/2}) |
| 1 | 120-125 | 80-85 | 2.9-3.1 | 6.0-7.0 | 120-130 | 3.0-3.2 | 0.75 |
| 2 | 120-125 | 75-85 | 3.1-3.2 | 5.5-7.0 | 125-130 | 2.9-3.0 | 0.60 |
| 3 | 125-135 | 85-90 | 2.8-3.1 | 5.9-6.8 | 125-130 | 3.0-3.1 | 0.57 |

From the mechanical properties described above, using the bisphenol-A based epoxy resin with Hardener #1 yields a system with a slightly higher fracture toughness and elongation than the other two systems. Using the catalyzed bisphenol-A based epoxy resin with Hardener #1 and Hardener #2 fracture toughness slightly decreased. In the case of Hardener #1 the tensile modulus was observed to increase and in the case of Hardener #2 the glass transition was observed to increase.

The results using the three resin/amine hardener combinations prepared and analyzed in the above Examples shows that the amine hardeners and catalyzed resin used in the filament winding process provides a curing system with a longer pot life which allows for the use of more versatile processing conditions.

Also as shown in the above Examples, a beneficial exotherm temperature reduction is gained by using the Hardener #2 formulation versus the Hardener #1 formulation using the catalyzed bisphenol-A based resin system. Exotherm temperature is an important property when dealing with pressure vessels with a liner that has a lower degradation temperature, such as a lower melting point high density polyethylene (HDPE). In addition, when using HDPE as a liner, the HDPE obtained from different sources can often yield slightly different properties.

### Example 2—General Processing

The system's epoxy resin can be a bisphenol-A-based or bisphenol-F-based epoxy system and a preferred embodiment of the system's curing package is a blend of two cycloaliphatic amines (4-ethylcyclohexane-1,3-diamine and 2-methylcyclohexane-1,3-diamine) and a tri-functional polyetheramine at a ratio of no greater than 70/30 and no less than 50/50, respectively. The system is accelerated using methyl-para-toluene sulfonate blended into the resin side at a weight fraction of 0-1% phr. The resin side and hardener side of the formulated system are mixed at 2,500 revolutions per minute (rpm) for 1 min in a mixer using centripetal motion to endure homogenous dispersion of the amine curative.

### Example 3—Specific Processing

A preferred embodiment of the system's epoxy resin is a bisphenol-A-based epoxy resin and a more preferred embodiment of the system's curing package is a blend of two cycloaliphatic amines (4-methylcyclohexane-1,3-diamine and 2-methylcyclohexane-1,3-diamine) and a tri-functional polyetheramine at a 60/40 ratio, respectively. The system is accelerated using methyl-para-toluene sulfonate blended into the resin side at a weight fraction of 0.25% phr. The resin side and hardener side of the formulated system are mixed at 2,500 RMP for 1 min in a mixer using centripetal motion to endure homogenous dispersion of the amine curative.

The filament winding process involves the pulling of fiber “tows” from a storage area and into the bath where the mixed resin system is stored in an open bath. While the fibers are submerged in the bath impregnation of the fiber bundle with the resin mixture takes place. The fiber as pulled from this bath, through a squeegee to remove excess resin and finally wound around a rotating mandrel where fiber is built (forming a composite structure) up on a high-density polyethylene liner involving both hoop (layers around the circumference of the HDPE liner) and helical layers (layers around the length of the HDPE liner).

When the winding has been completed, the composite cylinder will cure while still on the mandrel for 0-60 min (dwell time). Once the surface temperature of the composite part reaches 35° C. it is placed in an over at 80° C. for 2-3 hr. This curing schedule will produce a final part with an undamaged HDPE liner (operating temperature ˜100-110° C.) with a glass transition of ˜115-120° C. The system can be accelerated or decelerated using more or less catalyst (safe operating range: 0-1%) without impact of thermal or mechanical properties.

1. An amine hardener system useful for curing a curable resin composition comprising a blend of:
(I) a first amine hardener comprising at least one cycloaliphatic amine; and
(II) a second amine hardener comprising at least one polyetheramine.

2. The amine hardener system of claim 1, wherein the first amine, component (I), comprises at least two or more different cycloaliphatic amines.

3. The amine hardener system of claim 1, wherein the second amine, component (II), comprises at least two or more different polyether amines.

4. The amine hardener system of claim 1, wherein the first amine, component (I), is a combination of (i) at least two or more different cycloaliphatic amines and (ii) at least two or more different polyether amines.

5. The amine hardener system of claim 1, wherein the first amine hardener is 4-methylcyclohexane-1,3-diamine; 2-methylcyclohexane-1,3-diamine; 3-aminomethyl-3,5,5-trimethylcyclohexylamine; 1,8, methane diamene; 3,3-dimethylmethylene-di(cyclohexylamine); methylene-di(cyclohexylamine); 1,2-cyclohexanediamine; or mixtures thereof.

6. The amine hardener system of claim 1, wherein the second amine hardener is a di-functional polyether amine; a tri-functional polyetheramine; and mixtures thereof.

7. The amine hardener system of claim 1, including further at least a third amine hardener compound.

8. The amine hardener system of claim 7, including further at least a fourth amine hardener compound.

9. The amine hardener system of claim 8, wherein the third and/or fourth amine hardener component is an ethylene amine, a propylene amine, a polyamidoamine, an alkylene diamine, an alicyclic aliphatic amine, an araliphatic amine, adducts of any of the aforementioned amines, and combinations thereof.

10. A process for preparing an amine hardener system as claimed in claim 1, useful for curing a curable resin composition, comprising admixing:
(I) the first amine hardener comprising the at least one cycloaliphatic amine; and
(II) the second amine hardener comprising the at least one polyetheramine.

11. A curable epoxy resin composition comprising:
(A) at least one epoxy resin compound; and
(B) at least one curing agent; wherein the at least one curing agent comprises the amine hardener system of claim 1.

12. The curable epoxy resin composition of claim 11, wherein the at least one epoxy resin compound, component (a), is a bisphenol-A-based epoxy resin, a bisphenol-F-based epoxy resin, and mixtures thereof.

13. The curable epoxy resin composition of claim 11, including further a curing catalyst.

14. The curable epoxy resin composition of claim 13, wherein the catalyst is methyl-para-toluene sulfonate; ethyl-para-toluene sulfonate; or mixtures thereof.

15. The curable epoxy resin composition of claim 13, wherein the concentration of the catalyst is sufficient to tune the curing time of the curable composition with minimal impact to the thermal or mechanical properties of the curable composition and with minimal impact to a cured thermoset product made from the curable composition.

16. The curable epoxy resin composition of claim 15, wherein the concentration of the catalyst is from about 0.01 weight percent to about 5 weight percent.

17. A process for preparing a curable epoxy resin composition comprising admixing:
(A) at least one epoxy resin compound; and
(B) at least one curing agent; wherein the at least one curing agent comprises the amine hardener system of claim 1.

18. A cured article prepared by curing the curable epoxy resin composition of claim 11.

19. The cured article of claim 18, wherein the cured composite article is a composite article prepared by a filament winding process.

20-21. (canceled)

22. A filament winding process for manufacturing cured thermoset composite pressure vessels comprising the steps of:
(a) passing a dry filament reinforcement material through a bed of curable epoxy resin composition comprising:
(A) at least one epoxy resin compound; and
(B) at least one curing agent; wherein the at least one curing agent comprises the amine hardener system of claim 1;
(b) impregnating the dry filament reinforcement material with the curable resin composition to form a resin impregnated reinforcement material;
(c) winding the resin impregnated reinforcement material about the outer surface of a liner material disposed on a mandrel to form at least a partially cured composite article; and
(d) thermally curing the partially cured composite article on the liner material to form a substantially completely cured wound thermoset article.
